(19) United States
(12) Patent Application Publication
(10) Pub. No.: US 2004/0224206 A1
(43) Pub. Date: Nov. 11, 2004

(54) Polymer electrolyte fuel cell

(76) Inventors: Toshihiro Matsumoto, Osaka (JP); Takeshi Tomizawa, Ikoma-shi (JP); Katsuzou Kokawa, Uda-gun (JP); Teruhisa Kanbara, Osaka (JP); Susumu Kobayashi, Ikoma-shi (JP); Kazuhito Hatoh, Osaka (JP); Hiroki Kusakabe, Osaka (JP); Hideo Ohara, Osaka (JP); Shinsuke Takeguchi, Osaka (JP); Soichi Shibata, Osaka (JP)

Correspondence Address: MCDERMOTT, WILL & EMERY, 600 13th Street, N.W., Washington, DC, 20005-3096, US

(21) Appl. No.: 10/781,845

(22) Filed: Feb. 20, 2004

(30) Foreign Application Priority Data
Apr. 14, 2003 (JP) 2003-108880
Feb. 20, 2003 (JP) 2003-043004

(51) Int. Cl. H01M 8/10; H01M 8/24; H01M 8/04

(52) U.S. Cl. 429/32; 429/38; 429/26; 429/13

(57) ABSTRACT

A polymer electrolyte fuel cell stack includes cells having separators that can be supplied fuel or oxidant either in series or in parallel is disclosed. At high power loads the cells are operated in parallel, and at low power load the cells are operated in series. Advantageously, operating the cells in series at low power loading allows high gas flows thereby minimizing water condensation and improving the stability and performance of the cell stack during low load operation. Individual cells include a polymer electrolyte membrane sandwiched by a pair of electrodes, which in turn are sandwiched by a pair of electrically conductive separators. The separators have gas channels on their surfaces to supply oxidant gas and fuel gas to the cathode and anode, respectively, that can be manipulated to operate in parallel or series.

### FIELD OF THE INVENTION

The invention relates to a polymer electrolyte fuel cell that can be used as an electrical power source for various applications as such electric vehicles, home cogeneration systems, etc.

### BACKGROUND

A basic fuel cell consists of a pair of electrodes separated by an electrolyte. Fuel is supplied to the anode where it is converted to protons and electrons and an oxidant (e.g., oxygen from air) is supplied to the cathode. The protons pass through the electrolyte medium from the anode to the cathode where they react with oxygen to form water. The electrons pass through an external electrical circuit to the cathode to complete the reaction. In this way the fuel cell generates both heat and electricity.

In a polymer electrolyte fuel cell, the anode and cathode electrodes are formed on a polymer membrane that selectively transports hydrogen ions. The electrodes include a catalyst layer, which is composed of carbon powder to support a platinum metal catalyst, and a gas diffusion layer, which provides gas permeability and electron conductivity on the outer surface of the electrode. The polymer membrane in combination with the anode and cathode electrodes is commonly refer to a Membrane Electrode Assembly (MEA).

To prevent the fuel and oxidant that are supplied to the electrodes from leaking to the outside of the cell and from mixing with each other, gas seals and gaskets are provided around the electrodes and the polymer membrane. The gas seals and gaskets are integrated with the electrodes and polymer membrane and are assembled in advance. A fuel cell can contain up to 200 MEA's, for example. At least one electrically conductive separator is placed between adjacent MEA's to electrically connect the MEA's in series with each other, and to provide mechanical support. A groove or passageway on the separator provides a channel to supply gas to the electrode surface and to carry away formed water and excess gas.

Supplying the gas (fuel or oxidant) as evenly as possible to the electrode surface improves the gas use efficiency and the electric power output and helps to remove heat. It has been proposed that the gas channel formed on the side of the separator should have a meandering serpentine form, and that a plurality of such channels should be constructed in parallel (Japanese Patent Application Laid-open No. H07-263003).

Gas is supplied to the gas channel on each separator from a manifold which can be internal or external to the separators. The outlet from the gas channel is also connected to a manifold which carries away the formed water and excess gas.

Because the fuel cells generate heat, cooling water sections can also be provided, typically between every one to three cells. In a fuel cell structure, MEA's, separators and cooling sections are aligned in alternating layers to form a stack of 10-200 cells, and the ends of the stack are sandwiched with current collector plates and electrical insulating plates and the entire unit is secured with a fastening rod.

Typical polymer electrolyte material include fluorinated polymers having perfluoro sulfonate groups. In membrane form, this class of materials develop ion conductivity when they contain moisture and, thus, the fuel gas and oxidant gas are usually humidified before supplying the gases to the cell. The water vapor in the supply gas plus the water formed at the cathode can condense and, under extreme conditions, clog the gas channel or the electrode interior, a phenomenon known as flooding. Flooding causes unstable or decreased cell performance and loss of efficiency. Also, if flooding occurs on the anode side, it causes a shortage of fuel gas, which can be fatal to the cell. Moreover, if the load current on the cell is increased while fuel gas is lacking, the carbon that supports the anode catalyst can react with water in the atmosphere to produce electrons and protons in a fuel-less state. As a result, the carbon is consumed and the catalyst layer of the anode is destroyed.

To prevent flooding, the dew point of the supplied gas should be less than the operating temperature of the cell. Conversely, to improve ion conductivity of the polymer electrolyte and maintain cell performance, the supplied gas should have a relative humidity close to or greater than 100% (a dew point greater than the operating temperature of the cell). High humidity also protects the mechanical durability of the polymer membrane. Thus, the competing goals are to maintain high humidity and preventing flooding.

One method to avoid flooding involves increasing the gas flow rate at the separator passage section to blow off the water formed by condensation. However, in order to increase the gas flow rate, the supply gas pressure must be increased, which requires greater power consumption by the gas compressor or blower. The increased power consumption by the auxiliary equipment lowers the overall energy efficiency of the system.

In addition, during low load operation of a fuel cell, the fuel usage rate must be kept to the same level as the power output of the unit to maintain efficiency. For example, if power load is held at one half of the rated output, then the flow volumes of fuel gas and oxidant gas also need to be about one half, otherwise excessive fuel gas and oxidant gas are used and power generation efficiency decreases. However, the lower gas flow rates during low load operation may be insufficient to clear condensed water from the separators, leading to flooding.

Various configurations of fuel cells are known (43rd Battery Symposium, Japan, Oct. 2, 2002, Abstract 1D17). In the actual system, the gas inlet is connected to devices such as a humidifier, and the gas outlet is connected to devices such as heat exchanger, so a very complex valve switching operation is required to use manifold holes by switching to inlet and outlet as described above. Furthermore, because the upstream passage and downstream passage are connected with one manifold hole, when the divided passages are connected in series, condensed water formed by condensation in the manifold hole of the connection portion is passed downstream to the lower flow passage. As a result, the risk of flooding downstream increases.

It has also been disclosed that a lattice-shaped gas channel on a separator prevents condensate from accumulating in pools that would cause flooding. However, gas distribution throughout the lattice is not uniform and drainage is poor, such that one section may become blocked by condensed water. Another means to control flooding uses a single gas channel from the entrance to the exit. The single gas channel has good gas diffusion, but the flow resistance is greater and so the gas supply pressure must be increased, leading to greater power consumption by the equipment and overall loss of efficiency.

Another gas channel design that has been disclosed to control flooding is described in Japanese Patent Application Laid-Open No. H10-106594. The gas channel of the separator is formed by a lattice shaped entrance region and a lattice shaped exit region connected by a plurality of parallel channels. The parallel channels are folded back to criss-cross the separator several times, and the folded back regions between straight channel sections are lattice shaped. A disadvantage of this design is that the rate of gas diffusion is greater in the lattice shaped entrance side channel, causing the reaction rate and electrical output in this region to be higher, so that the reaction is concentrated in the entrance side channel part. As a result, the catalyst layer and gas diffusion layer of the electrode deteriorate at a faster rate in the entrance side channel, causing a loss of durability. At the exit side channel groove part, although drainage is good because of the large cross-sectional area of the channel, gas flow is not evenly distributed. In the regions where the gas flow is low, condensate may accumulate and block the channel grooves, with the result that gas can not be supplied to this part, and flooding occurs.

Accordingly, a continuing need exists to provide a reliable fuel cell that addresses flooding and low-load performance problems while maintaining a steady gas flow rate during low load operation.

### SUMMARY OF THE INVENTION

An advantage of the present invention is a fuel cell that can be operated with improved efficiency and which minimizes the propensity for internal water condensation.

According to the present invention, the foregoing and other advantages are achieved in part by a fuel cell stack comprising cells that can operate with independent gas (e.g., fuel gas and/or oxidant gas) flows. In one embodiment of the present invention, the fuel cell stack includes at least one cell A and at least one cell B. The fuel cell stack can comprise a plurality of alternating A and B cells.

In one aspect of the present invention, cell A comprises a first and second separator disposed between and contacting opposing surfaces of an MEA. The first separator has an inlet manifold to direct gas to and across one surface of the MEA and an outlet manifold in fluid communication with (i.e. linked) to the inlet manifold to direct gas away from the one surface of the MEA. Cell B, similarly comprises a first and second separator disposed between and contacting opposing surfaces of an MEA. The first separator of cell B, however, has a first and second inlet manifold to direct gas to and across one surface of the MEA and a first and second outlet manifold linked to the first and second inlet manifolds, respectively, to direct gas away from the one surface of the MEA.

Cell A and cell B can be operated in series by providing gas to the outlet of the first separator of cell A, which is linked to the second inlet manifold of the first separator of cell B. Conversely, cell A and B can be operated in parallel by providing gas to the inlet manifolds of each separator. Advantageously, both the cathode side and anode side separators of cells A and B can have the same arrangement so that both fuel gas and oxidant can be provided in parallel or serially depending on the power load of the cell stack.

Another aspect of the present invention is a fuel cell stack comprising a plurality of unit cells, each of which comprises: a first and second separator disposed between and contacting opposing surfaces of an MEA. In this embodiment, the first separator has at least two independent gas passages to supply gas across one surface of the MEA, and each of the at least two independent gas passages has an inlet and an outlet manifold.

Advantageously, the separator in this aspect of the present invention employs a plurality of independent gas passages, which have respectively independent inlet side manifold holes and outlet side manifold holes in the surface that opposes at least one of the electrodes of the electrically conductive separator. The fuel cell stack can then be operated by switching the multiple gas passages to operate in series or in parallel.

Yet another aspect of the present invention is a method of operating a fuel cell stack, the method comprising: supplying fuel gas to a plurality of cathode side separators in parallel during a first power mode; and supplying fuel gas to the plurality of cathode side separators in series during a second power mode.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The various features and advantages of the present invention will become more apparent and facilitated by reference to the accompanying drawings, submitted for purposes of illustration and not to limit the scope of the invention, where the same numerals represent like structure and wherein:

FIGS. 1-8 illustrate the configuration of an anode and cathode separator of a fuel cell in accordance with a first embodiment of the present invention and, in particular,

FIG. 1 is the front view of the cathode side separator of cell A;

FIG. 2 is the front view of the anode side separator of cell A;

FIG. 3 is the front view of the cathode side separator of cell B;

FIG. 4 is the front view of the anode side separator of cell B;

FIG. 5 is the front view of the cathode side separator of cell A and showing the flow of oxidant gas through the separator when it is operated in series with cell B;

FIG. 6 is the front view of the anode side separator of cell A and showing the flow of fuel gas through the separator when it is operated in series with cell B;

FIG. 7 is the front view of the cathode side separator of cell B and showing the flow of oxidant gas through the separator when it is operated in series with cell A;

FIG. 8 is the front view of the anode side separator of cell B and showing the flow of fuel gas through the separator when it is operated in series with cell A;

FIG. 9 is a perspective view of a fuel cell stack including cells A and B of the first embodiment of the present invention.

FIG. 10 is a perspective view illustrating a fuel cell stack in accordance with second embodiment of the present invention.

FIG. 11 is the front view illustrating the cathode side of an electrically conductive separator that is employed in a fuel cell in accordance with a third embodiment of the present invention.

FIG. 12 is the front view of the anode side of the separator of Embodiment 3.

FIG. 13 shows the switching of the gas passages on the cathode side of the separator of Embodiment 3.

FIG. 14 illustrates the cathode side piping arrangement for the fuel cell of Embodiment 3.

FIG. 15 illustrates the cathode side piping arrangement for a fuel cell in accordance with a fourth embodiment of the present invention.

FIG. 16 is a graph showing the measured voltage output as a function of current load for the fuel cell of Example 1. Comparative data for a conventional fuel cell is also shown.

FIG. 17 shows the measured current/voltage characteristic for the fuel cell of Example 3. Comparative data for a conventional fuel cell is also shown.

FIG. 18 shows the measured current/voltage characteristic for the fuel cell of Example 4. For comparison, the current/voltage characteristic of the fuel cell of Example 3 is also shown.

FIG. 19 shows the measured voltage as a function of time for the fuel cell of Example 5. The comparative example shows the result for gas flowing against gravity.

### DESCRIPTION OF THE INVENTION

The configuration of the separators in conventional fuel cells was structured in such a way that each of fuel gas and oxidant gas was supplied from one inlet side manifold to the gas passage of the separator and then discharged through one outlet side manifold. The gas channels in conventional fuel cells were further designed to provide the most suitable flow rate at the rated output of the fuel cell. However, when the electric power load decreased, the flow rate in the channel also necessarily decreased to maintain efficient operation. During reduced flow rates, however, it becomes difficult to efficiently remove condensed water from accumulating in the channel, and flooding tends to occur. Conversely, if the gas flow is not reduced when the electric power load decreased, then the ratio of power consumption by the auxiliary equipment such gas compressors to the electric power generated by the fuel cell becomes relatively large, and the overall efficiency of the system decreased. In order to improve the quality and efficiency of the fuel cell power generation, it is preferable to vary the load of the fuel cell according to power demand without sacrificing power generation efficiency.

The present invention addresses the propensity for condensation accumulation in a polymer electrolyte fuel cell and the attendant instability and decreased performance that typically occur during low load operations. The present invention contemplates arrangements of a fuel cell that have gas channels in separators that can be operated in parallel under conditions of high power load and in series under conditions of low power load and means for supplying gas to a plurality of separators parallelly during a first power mode and serially during a second power mode. The series/parallel gas channels can be arranged on different separators or they can be arranged on the same separator of a cell in a fuel cell stack.

In one embodiment of the present invention, a fuel cell stack includes at least two types of cells, denoted A and B, in which at least two types of the separator pairs sandwich an MEA. The MEA comprises an anode and a cathode separated by a polymer electrolyte membrane. Fuel gas (e.g., hydrogen) is supplied to the anode of cell A through an entrance side manifold hole in the anode side of separator pair A. Oxidant gas is supplied to the cathode of cell A through an entrance side manifold hole in the cathode side of separator pair A. Similarly, fuel gas is supplied to the anode of cell B through an entrance side manifold hole in the anode side of separator pair B. And oxidant gas is supplied to the cathode of cell B through an entrance side manifold hole in the cathode side of separator pair B. In this way, gas can be supplied in parallel to cells A and B.

During low load operation, the exit side manifold holes of cell A and cell B are connected in series and gas is supplied from the entrance side manifold hole in manifold A, so that gas flows in series through cell A and cell B and is discharged from the entrance side manifold hole in manifold B.

According to this aspect of the present invention, one or both the fuel gas and the oxidant gas can be supplied in parallel or in series to cell A and cell B, in response to the electrical load on the fuel cell. The advantage is that the flow rates in the gas channels are kept uniform, regardless of the load, and the instability and decrease in cell performance that typically occur during low load operation are avoided.

Because of the ability to switch between series and parallel operation of the cells by switching between different supply manifolds, as described above, flooding of the cell stack during low load operations is minimized. For example, when the ratio of the highest load electric power output and the lowest load electric power output is two to one, two gas supply manifolds are provided, with the gas channels of cells of type A supplied by manifold A, and the gas channels of cells of type B supplied by manifold B, for both the fuel gas and oxidant gas supply manifolds.

During periods of high electric power generation, gas is supplied in parallel to cells A and B. During periods of low load operation, gas is supplied from manifold A to cell A, the discharge manifold is blocked, and the gas is routed through cell B and out through manifold B, which is then used as a discharge manifold rather than a supply manifold. By this means, the same gas flow rate can be maintained in all gas channels.

When gas channels are operated in series, since each channel is connected to an independent manifold hole, it becomes possible to discharge the condensed water through the intermediate manifold hole to piping outside the separator. Since the condensed water is not carried to the downstream channel, a more stable operation is possible.

Furthermore, a mist trap can be inserted in the connection part of a manifold hole to remove the condensed water.

### EMBODIMENT 1

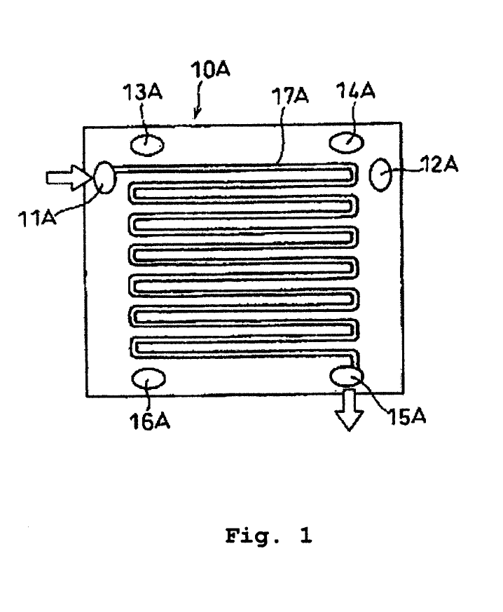

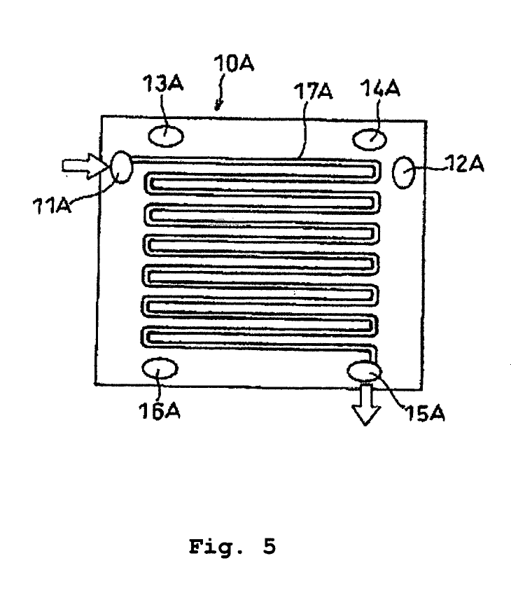

Reference is now made to the accompanying drawings where FIGS. 1-8 illustrate the configuration of an anode and cathode separator of a fuel cell in accordance with a first embodiment of the present invention. FIGS. 1-4 show a cathode and anode side separators of cells A and B and further illustrate the flow of oxidant and fuel gas through the separators when operated in parallel. Conversely, FIGS. 5-8 show a cathode and anode side separators of cells A and B and when operated in series.

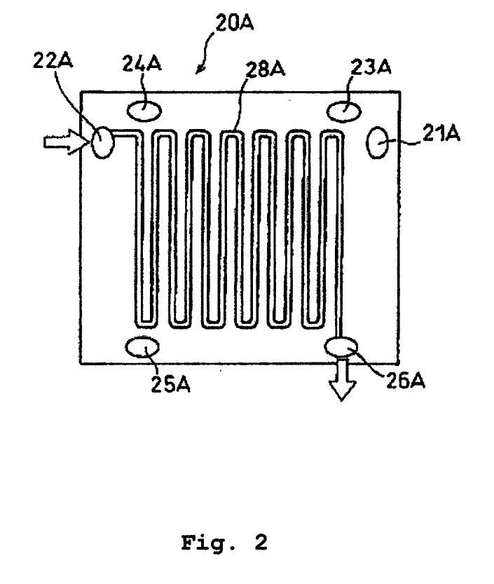

In particular, FIG. 1 shows the cathode side separator 10A and FIG. 2 shows the anode side separator 20A which together form separator pair A for cell A. In FIG. 1, cathode side separator 10A has oxidant gas manifold holes 11A, 13A and 15A, and fuel gas manifold holes 12A, 14A and 16A. Separator 10A also has a gas channel 17A that connects manifold holes 11A and 15A and supplies oxidant gas to the surface of the cathode.

In FIG. 2, anode side separator 20A has fuel gas manifold holes 22A, 24A and 26A, and oxidant gas manifold holes 21A, 23A and 25A. Separator 20A also has gas channel 28A that connects manifold holes 22A and 26A and supplies fuel gas to the surface of the anode.

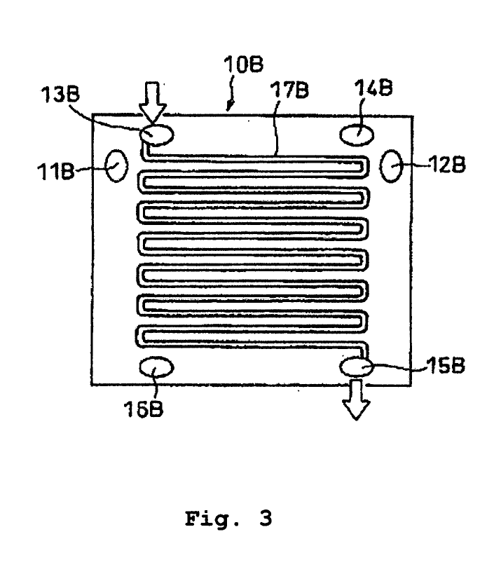

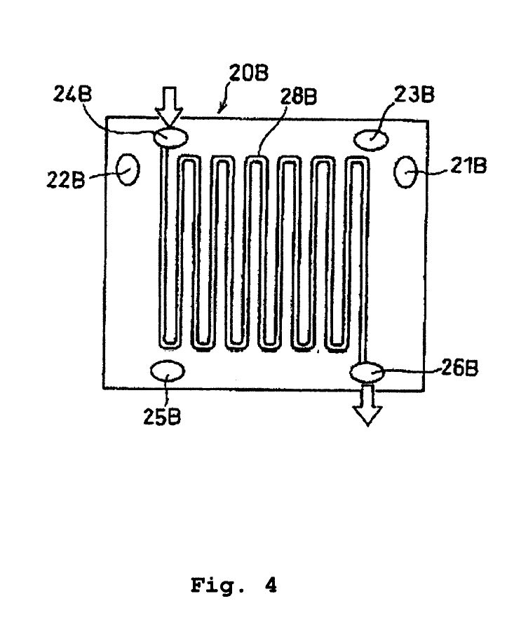

FIG. 3 shows the cathode side separator 10B and FIG. 4 shows the anode side separator 20B which together form separator pair B for cell B. In FIG. 3, cathode side separator 10B has oxidant gas manifold holes 11B, 13B and 15B, and fuel gas manifold holes 12B, 14B and 16B. Separator 10B also has gas channel 17B that connects manifold holes 13B and 15B and supplies oxidant gas to the surface of the cathode.

In FIG. 4, anode side separator 20B has fuel gas manifold holes 22B, 24B and 26B, and oxidant gas manifold holes 21B, 23B and 25B. Separator 20B also has gas channel 28B that connects manifold holes 24B and 26B and supplies fuel gas to the surface of the anode.

The MEA, which is sandwiched by separators, comprises a polymer electrolyte membrane of the same size as the separators, a pair of gas diffusion electrodes (anode and cathode) that sandwich the polymer electrolyte membrane, and a pair of gaskets that seal the part of the membrane that protrudes beyond the edge of the electrodes. This MEA constitutes cell A sandwiched by separators 10A and 20A. In the same way, a second MEA constitutes cell B sandwiched by separators 10B and 20B. Multiple cells A and B can then be alternatively arranged to form a cell stack and cell body.

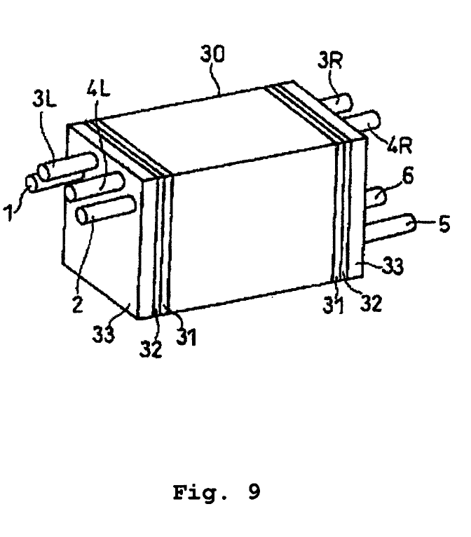

FIG. 9 shows a fuel cell body in accordance with one aspect of the present invention. The cell body 30 is sandwiched by end plates 33 with insulating plates 32 and current collecting plates 31 inside the end plates and fastened by bolts (not illustrated). FIG. 9 also shows a number of manifolds attached to the end plates of the fuel cell. Manifold 1 is the oxidant gas manifold for cells A and links manifold holes 11A, 11B, 21A and 21B (FIG. 1-4). Manifold 3L is the oxidant gas manifold for cells B and links manifold holes 13A, 13B, 23A and 23B. Manifold 2 is the fuel gas manifold for cells A and links manifold holes 12A, 12B, 22A and 22B. Manifold 4L is the fuel gas manifold for cells B and links manifold holes 14A, 14B, 24A and 24 B. At the other end plate, manifold 3R is the oxidant gas manifold for cells B and links manifold holes 13A, 13B, 23A and 23B. Manifold 4R is the fuel gas manifold for cells B and links manifold holes 14A, 14B, 24A and 24B. Manifold 5 is the oxidant gas manifold that links manifold holes 15A, 15B, 25A and 25B. Manifold 6 is the fuel gas manifold that links manifold holes 16A, 16B, 26A and 26B.

As is understood by those skilled in the art, the operation of a fuel cell in accordance with the present invention can be computer controlled for optimum results. For example, when operating at the full rated output of the fuel cell, oxidant gas and fuel gas are supplied in parallel to cells A and B. Manifold 3R is closed and oxidant gas is supplied equally to manifolds 1 and 3L (FIG. 9). In separator 10A (FIG. 1), oxidant gas flows from manifold hole 11A through gas channel 17A and is discharged from manifold hole 15A. In separator 10B (FIG. 3), oxidant gas flows from manifold hole 13B through gas channel 17B and is discharged from manifold hole 15B. Similarly, manifold 4R is closed and fuel gas is supplied equally to manifolds 2 and 4L (FIG. 9). In separator 20A (FIG. 2), fuel gas flows from manifold hole 22A through gas channel 28A and is discharged from manifold hole 26A. In separator 20B (FIG. 4), fuel gas flows from manifold hole 24B through gas channel 28B and is discharged from manifold hole 26B.

When operating at one half of the rated output of the fuel cell, manifolds 3L, 4L, 5 and 6 are closed, oxidant gas is supplied to manifold 1, and fuel gas is supplied to manifold 2. Oxidant gas and fuel gas then flow through cells A and B in series, and are discharged from manifolds 3R and 4R.

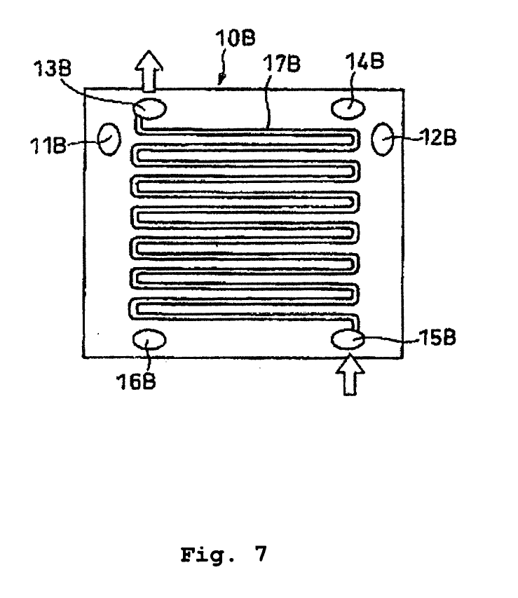

As shown by the arrow in FIG. 5, the oxidant gas supplied to manifold 1 enters separator 10A at manifold hole 11A and flows through gas channel 17A to be discharged at manifold hole 15A. Next, as shown by the arrow in FIG. 7, the gas enters manifold hole 15B of separator 10B and flows through gas channel 17B to be discharged through manifold hole 13B.

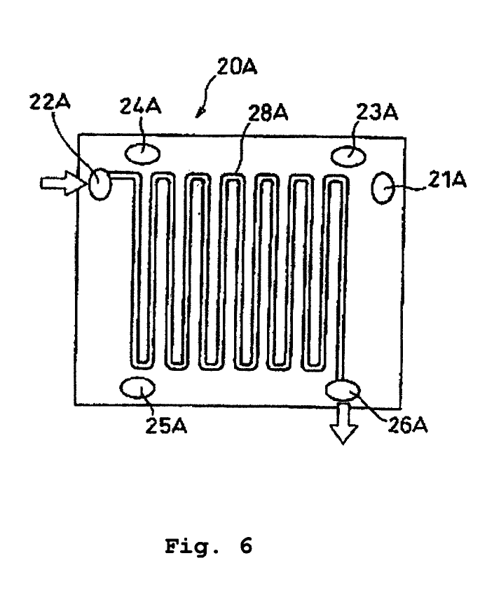

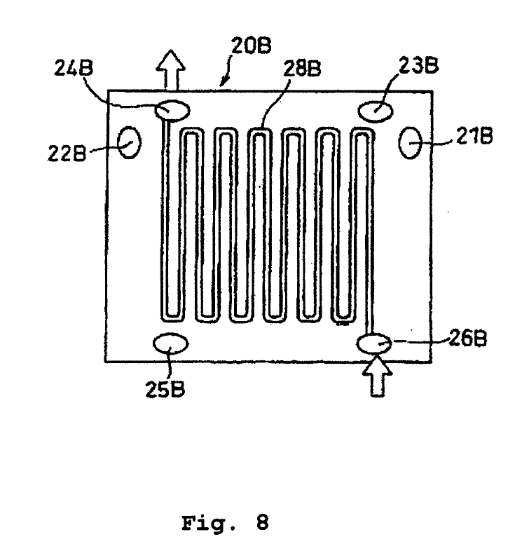

Similarly, the fuel gas supplied to manifold 2, as shown by the arrow in FIG. 6, enters separator 20A at manifold hole 22A and flows through gas channel 28A to be discharged through manifold hole 26A. Next, as shown by the arrow in FIG. 8, the gas enters manifold hole 26B of separator 20B, flows through gas channel 28B, and is discharged through manifold hole 24B.

### EMBODIMENT 2

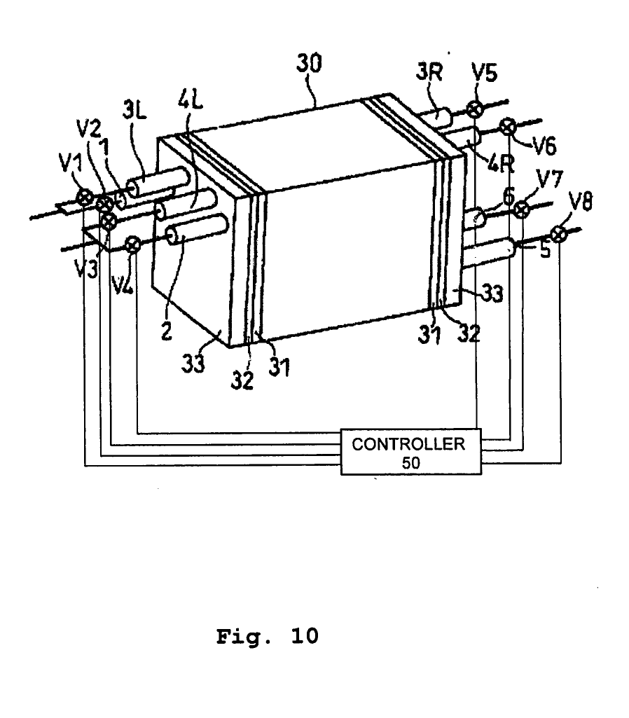

The operation of a fuel cell stack with at least two cells that can be operated in parallel and in series will be provided with reference to the embodiment shown in FIG. 10. The difference between the arrangement shown in FIG. 10 and that of embodiment 1 is that valves have been provided on the piping of each manifold. Each valve can be operated by a controller, such as a microprocessor, which actuates the various valves in response to a power mode of the fuel cell for optimum results. Such controllers and there integration are understood by those skilled in the art. The process for controlling the fuel cell of FIG. 10, for example, includes measuring a condition of the cell, e.g., voltage and current, for output power. When the condition indicates a low power mode, e.g., when the voltage and current are lower than a predefined value, the valves are switched or maintained so that gas flow is provided in series to the cells. When the condition indicates a high power mode, the controller operates the fuel cell stack in a parallel mode.

As shown in FIG. 10, oxidant gas supply manifolds 1 and 3L are connected to one oxidant gas supply pipe via valves V2 and V1, respectively. Oxidant gas supply manifold 3R is provided with valve V5, and oxidant gas discharge manifold 5 is provided with valve V8. Fuel gas supply manifolds 2 and 4L are connected to one fuel gas supply pipe via valves V4 and V3, respectively. Fuel gas supply manifold 4R is provided with valve V6, and fuel gas discharge manifold 6 is provided with valve V7. Controller 50 is connected to each valve to operate the fuel cell.

When oxidant gas is supplied in parallel to cells A and cells B, valves V1, V2 and V8 are opened and valve V5 is closed, causing oxidant gas to be supplied from manifolds 1 and 3L and discharged from manifold 5. Similarly, when fuel gas is supplied in parallel to cells A and cells B, valves V3, V4 and V7 are opened and valve V6 is closed, causing fuel gas to be supplied from manifolds 2 and 4L and discharged from manifold 6.

When oxidant gas is supplied in series to cells A and cells B, valves V2 and V5 are opened and valves V1 and V8 are closed, causing oxidant gas to be supplied from manifold 1 and discharged from manifold 3R. Similarly, when fuel gas is supplied in series to cells A and cells B, valves V4 and V6 are opened and valves V3 and V7 are closed, causing fuel gas to be supplied from manifold 2 and discharged from manifold 4R.

The separators discussed so far have gas channels cut on only one side. It is also contemplated that the separator have channels on both sides, so that one side functions as a cathode side separator of a first cell and the other side functions as the anode side separator of a second cell. For example, when cell A and cell B are arranged adjacent to each other, one side of the separator is the cathode side separator of cell A and the other side of the separator is the anode side separator of cell B.

In addition, the separator can also have a manifold hole for cooling water and a cooling water channel. The cooling part normally has a cooling water channel on the facing surfaces of the cathode side separator and the anode side separator. This cooling part can be provided for each cell or for each two to three cells.

In a separate embodiment of the present invention, switching between series and parallel operation is achieved by providing a plurality of independent gas passages on an individual separator. Each gas passage has an independent inlet side manifold hole and an independent outlet side manifold hole in the separator. The passages are operated in series by connecting the outlet side manifold hole of the upstream gas passage with the inlet side manifold hole of the downstream gas passage by piping provided outside of the separator.

In one aspect of the present invention, the gas passages on the separator are arranged so that the direction of gas flow is never against gravity, i.e. the separator has gas channels that run across the electrode surface meandering predominately in the horizontal and downward direction rather than having a flow which results in an upward direction. A mist trap can also be connected between the outlet side manifold hole of the upstream side gas passage and inlet side manifold hole of the downstream side gas passage. Although the plurality of independent gas passages can be either anode side only or cathode side only, it is preferred to provide independent gas passages for both anode and cathode side separators.

By forming a plurality of independent gas passages that employ independent manifolds on the inlet side and outlet side in the separator surface and connecting them in series or parallel, this embodiment of the present invention minimizes the tendency of fuel cell flooding during low load operations. For example, if the ratio of the maximum load power generation output and the minimum load power generation output is 4 to 1, four independent gas passages are formed in the separator surface, and the gas is supplied through all gas passages in parallel during the maximum load operation, and the gas is supplied through all four gas passages connected in series during the minimum load operation. Also, for operation with medium load, gas is supplied where two adjacent gas passages among the four gas passages are connected in series. By doing this, the same gas flow rate can be maintained in all gas passages even when the load fluctuates.

Moreover, when the gas passages are connected in series, stable operation can be achieved by employing a connection method for each gas passage where a pipe is used to connect the independent manifold holes outside the separator, e.g. outside of the cell stack. Proving such a connection allows the discharging of condensed water formed by condensation in the in-between manifold hole to outside of the separator, thereby preventing the condensed water from being supplied to downstream passages.

Furthermore, by inserting a mist trap at the connection of the manifold hole, discharge of the condensed water can be performed with assurance. Further, in order to facilitate the discharging of the condensed water, it is desirable to send the gas that flows in each gas passages in directions that do not oppose gravity. By employing a structure in which the direction of gas flow does not change when each gas passage is switched between series and parallel, it is possible to have the gas always flow in directions that do not oppose gravity, making more stable operation possible.

### EMBODIMENT 3

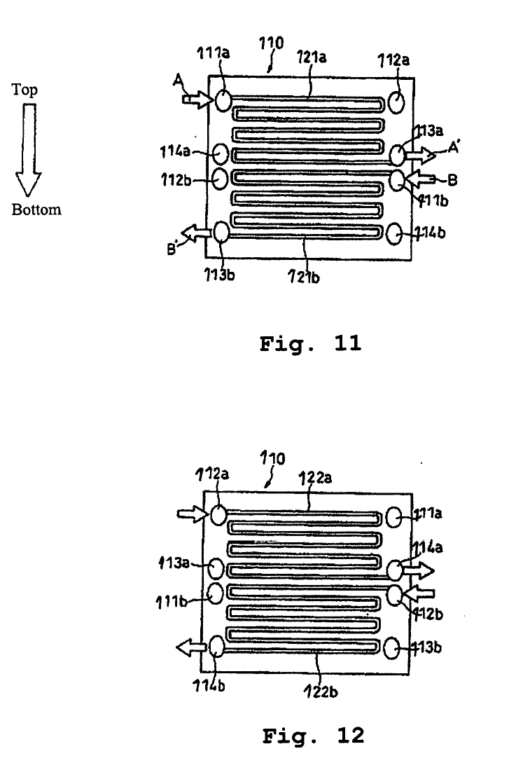

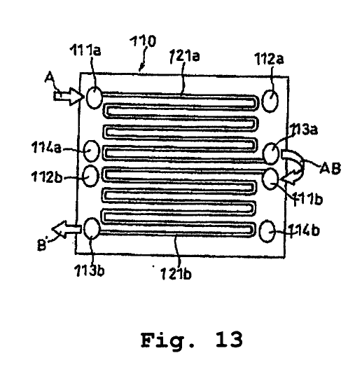

FIG. 11 shows the front view of the cathode side of the electrically conductive separator 110, and FIG. 12 shows the front view of the anode side of separator 110. The separator has gas channels on both sides, one side contacting the cathode, and the other side contacting the anode of the adjacent cell. In FIGS. 11 and 12, the electrically conductive separator 110 employs the first and the second oxidant gas inlet side manifold holes 111a and 111b, the first and the second outlet side manifold holes 113a and 113b, the first and the second fuel gas inlet side manifold holes 112a and 112b, and the first and the second outlet side manifold holes 114a and 114b. In FIG. 11, on the cathode side, the separator 110 employs the first gas passage 121a connecting the first inlet side manifold hole 111a to the first outlet side manifold hole 113a, and the second gas passage 121b connecting the second inlet side manifold hole 111b to the second outlet side manifold hole 113b. In FIG. 12, on the anode side, the separator 110 employs the first gas passage 122a connecting the first inlet side manifold hole 112a to the first outlet side manifold hole 114a, and the second gas passage 122b connecting the second inlet side manifold hole 112b to the second outlet side manifold hole 114b.

The method of supplying oxidant gas to the cells in this embodiment is as follows. While operating at rated output, oxidant gas is supplied in parallel to the first inlet side manifold hole 111a and through the first gas passage 121a to the first outlet side manifold 113a, and to the second inlet side manifold hole 111b through the second gas passage 121b to the second outlet side manifold 113b.

When operating at a load of one half of the rated output, the first gas passage 121a and the second gas passage 121b are connected in series, as shown in FIG. 13. That is, the first outlet side manifold hole 113a and the second inlet side manifold hole 111b are connected outside of the cell as indicated by arrow AB. By this arrangement, the gas coming into the first inlet side manifold hole 111a at arrow A flows through passage 121a to the first outlet side manifold hole 113a and then enters the second inlet side manifold hole 111b and flows through the second gas passage 121band is discharged to the outside through the second outlet side manifold hole 113b.

The method of supplying fuel gas is exactly the same as the method described for the oxidant gas, except that the fuel gas manifolds and fuel gas passages on the anode separators are utilized.

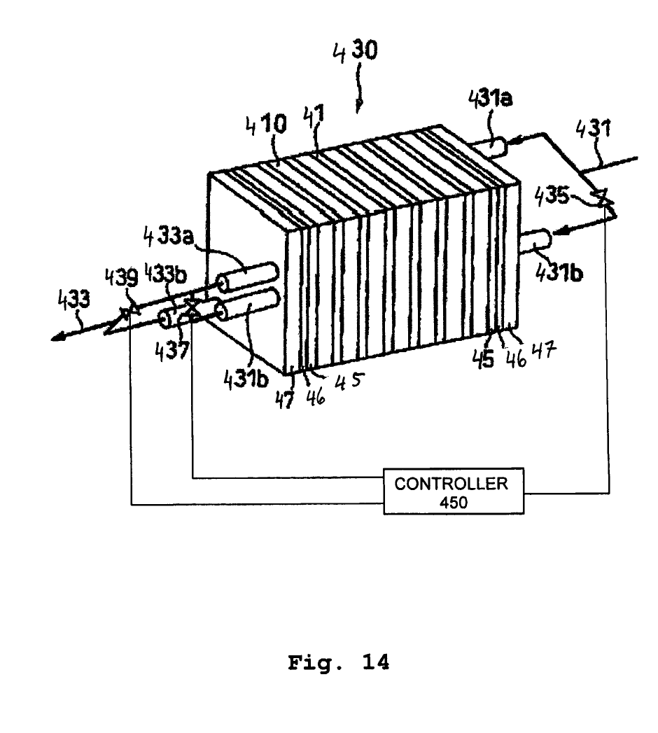

FIG. 14 illustrates the piping arrangement of the oxidant gas system of a cell stack equipped with a separator such as the one described above. The fuel cell 430 comprises the cell stack that is formed by alternately layering MEA 41 and separator 410, each pair of the current collector plates 45, the electrical insulation plates 46, and the end plates 47 that sandwich the cell stack, and the fastening means to hold them together. The pipe 431 that is connected to the supply source of oxidant gas branches into the first pipe 431a and the second pipe 431b. Pipe 431b employs valve 435. The first pipe 431a is connected to the manifold provided in the fuel cell through the first inlet side manifold hole 411a of the separator 410, and the second pipe 431b is connected to the manifold provided in the fuel cell through the second inlet side manifold hole 411b of the separator 410. In a similar manner, pipes 433a and 433b, which connect to the manifolds that respectively go through the first outlet side manifold hole 413a and the second outlet side manifold hole 413b of the separator 410, are provided. Pipe 433a, which employs valve 439, and pipe 433b are connected to the outlet side pipe 433. One end of pipe 431b is connected to pipe 433a through the bypass valve 437. Controller 450 is connected to each valve, 435, 437 and 439 to operate the fuel cell in various modes by opening and closing the various valves.

In FIG. 14, for illustrative simplicity, only the piping arrangement on the cathode side is shown. The piping on the anode side can be similarly structured by arranging it symmetrically on the anode side separator.

In one aspect of the present invention, the pipes 431a and 431b branching from pipe 431 and the pipes 433a and 433b connecting to pipe 433 have an identical pipe diameter so that gas will divide in equal proportion between the branching pipes. To distribute the gas equally, it is also preferable to maintain the same length for the two branching pipes to equalize the pressure loss in each pipe. Similarly, it is preferable to make the length of the two gas passages in FIG. 12 the same in order to equalize the pressure loss in the two independent gas passages.

When the fuel cell is operated, such as by controller 450, at the rated output load, valves 435 and 439 are opened, and the bypass valve 437 is closed. The oxidant gas supplied through pipe 431 flows from pipes 431a and 431b to the first and the second gas passages through manifold holes 111a and 111b, respectively, and is discharged to pipe 433 through pipes 433a and 433b. During operation at one half of the rated output load, valves 435 and 439 are closed and the bypass valve 437 is opened. The oxidant gas is supplied from pipe 431a, flows through the first gas passage and into pipe 433a, then flows through the bypass valve 437 and into pipe 431b, then it flows through the second gas passage and is discharged to pipe 433b and exits to pipe 433.

Each valve can be controlled by a controller, such as a microprocessor, which actuates the various valves in response to a power mode of the fuel cell for optimum results. Such controllers and their integration are understood by those skilled in the art. The process for controlling the fuel cell of FIG. 11, for example, includes measuring a condition of the cell, e.g., voltage and current, for output power. When the condition indicates one or more low power modes, e.g., when the voltage and current are lower than one or more predefined values, the valves are switched or maintained so that gas flow is provided in series or partial series depending upon the number of independent sections of the separator to the cells. When the condition indicates a high power mode, the controller operates the fuel cell stack in one or more parallel modes.

The flow passages and manifold holes for cooling water have been omitted in FIGS. 11 and 12. Nonetheless, it is possible to structure the coolant system to switch according to the load in the same manner as the gas passages by dividing the cooling water passages into multiple passages in a way similar to the switching of the gas passages. The separator described above is used for both the anode side separator and the cathode side separator, and the cooling section resulting from cooling water can be structured as explained below. On the cathode side separator, oxidant gas passages such as those shown in FIG. 11 are formed on one side and cooling water passages are formed on the other side. And on the anode side separator, fuel gas passages such as those shown in FIG. 12 are formed on one side and cooling water passages are formed on the other side. The two separators are combined so that the cooling water passages face each other. The cooling water separators are inserted between MEA's as needed. It would not be necessary to divide the cooling sections in multiple parts like the gas passages if the cooling sections were not provided in every cell.

### EMBODIMENT 4

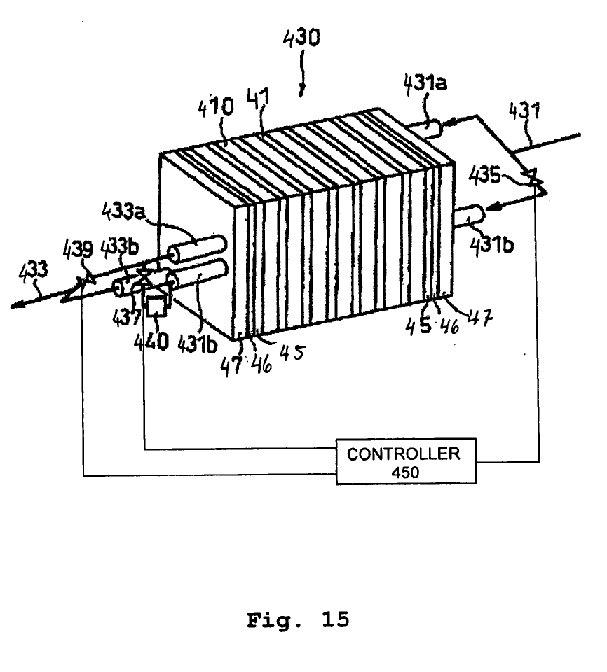

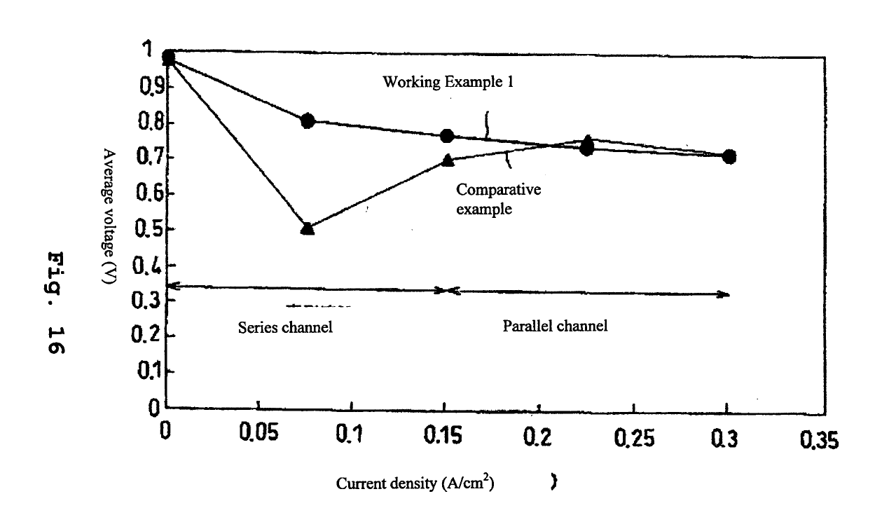

As shown in FIG. 15, the mist trap 440 is inserted into the pipe that connects the first outlet side manifold 433a and the second inlet side manifold 431b from Embodiment 3. When the reactive gas is supplied at close to 100% relative humidity, the gas can contain substantial amounts of mist after passing through the first gas passage, because of water formed in the reaction and condensed water. If the mist is supplied to the downstream gas passages, the risk of flooding increases. Inserting the mist trap prevents the mist which is discharged from the first gas passage from entering the downstream gas passages, eliminating the risk of flooding. The water caught by the mist trap can be collected and recycled for other uses. The mist trap can be a commercially available mechanical mist trap, or a wick type trap which contains fiber and absorbs water such as the kite string type.

### EXAMPLE 1

The cathode catalyst was composed of 25% by weight platinum particles on acetylene black group carbon powder. The platinum particles had an average particle diameter of approximately 30 Å. The anode catalyst was composed of 25% by weight platinum-ruthenium alloy particles on acetylene black group carbon powder. The platinum-ruthenium alloy particles had an average particle diameter of approximately 30 Å. Catalyst powder was dispersed in isopropanol and mixed with a dispersion of perfluorocarbon sulfonic acid powder in ethyl alcohol. (FLEMION, manufactured by Ashai Glass Co., Ltd.) The mixture was made into a paste. Using the screen-printing method, the paste was applied to one surface of a carbon non-woven fabric of thickness of 250 μm (code number TGP-H-090 manufactured by Toray Industries, Inc.) and dried. In this way, the cathode catalyst layer and the anode catalyst layer were formed. The amount of platinum contained in the catalyst layers was 0.3 mg/cm², and the amount of perfluorocarbon sulfonic acid was 1.2 mg/cm^{2.}

The MEA's were made from the respective catalyst layers as follows. The printed catalyst layers were bonded with a hot press to both sides of the polymer electrolyte membrane (NAFION 112, manufactured by DuPont, USA), the cathode on one side and anode on the other. Since the polymer electrolyte membrane has a surface area larger than the electrode, a gasket was applied to the exposed area. The gasket was cut from a sheet of elastomer (Viton AP of DuPont Co., Ltd., thickness 250 μm, hardness 500) to the appropriate size and applied to both surfaces of the polymer electrolyte membrane that are exposed at the external periphery of the electrode. The gasket was joined and integrated to the membrane with a hot press. The hydrogen ion conductive polymer electrolyte membrane was a perfluorocarbon sulfonic acid membrane of thickness of 30 μm.

Separators of type 10A, 10B, 20A and 20B shown in FIG. 1-4 were made as follows. The gas channels and manifold holes were formed by means of machining an isotropic graphite plate of a thickness of 3 mm. The groove width of the gas channel was set to 2 mm, the depth was set to 1 mm, the width of the rib between gas channels was set to 1 mm, and all of the gas channels were made in a single pass.

Cell A, which combined the cathode side separator 10A and the anode side separator 20A in the above-mentioned MEA, and cell B, which combined the cathode side separator 10B and the anode side separator 20B in the MEA, were alternately piled up to constitute a cell stack body comprising 50 cells. The cell stack body was sandwiched by stainless steel end plates, insulating plates made of polyphenylene sulfide, and current collecting plates made of gold plated copper. The end plates were fastened by fastening rods. The fastening pressure was 10 kgf/cm² per area of electrode.

The mode of operation was as follows. When operating at rated conditions, oxidant gas and fuel gas were supplied in parallel to cells A and cells B. When operating at low load of 50% or less of the rated output, oxidant gas and fuel gas were supplied in series to cell A and cell B, respectively. The rated operating conditions of the cell are fuel utilization rate 75%, oxygen utilization rate 40%, and current density 0.3 A/cm².

The fuel cell was maintained at 70° C. A fuel gas that was 80% hydrogen and 20% carbon dioxide with 10 ppm carbon monoxide was humidified and heated to a dew point of 70° C. Air (the oxidant gas) was also humidified and heated to form a dew point of 70° C. The current density was varied from 0.075 A/cm², corresponding to a low load of 25% of the rated output, up to the rated output current density of 0.3 A/cm², and the current-voltage characteristics were evaluated. The utilization rate during the test was set to be the same as the rated conditions. The results are shown in FIG. 16. For current density below 0.15 A/cm² the cells were operated in series, and for current density above 0.15 A/cm² the cells were operated in parallel. FIG. 16 shows that flooding did not occur and the operation was stable for the fuel cell built according to Example 1, even when operating at 0.075 A/cm². For comparison, FIG. 16 also shows the recorded data for a conventional fuel cell having only one type of cell. At a current density of 0.075 A/cm², flooding occurred and operation was difficult in the conventional fuel cell because of the lower gas flow rate. In this example, only two types of cells were used, but, by increasing the number of manifolds, more cells could be connected in series in the same way.

### EXAMPLE 2

In Example 2, valves were provided on the piping as described in Embodiment 2. By opening and closing the valves, the supply of gas was switched between parallel and series operation of the cells. The same experiment was performed as in Example 1. The results obtained were also the same as in Example 1.

### EXAMPLE 3

A cathode catalyst was produced by supporting 25% by weight platinum particles having average diameter of approximately 30 Å on acetylene black type carbon powder. An anode catalyst was produced by supporting 25% by weight platinum-ruthenium alloy particles having average diameter of approximately 30 Å on acetylene black type carbon powder. The catalyst powder was dispersed in isopropanol, and a paste-form ink was fabricated by mixing it with a dispersion perfluorocarbon sulfonate powder in ethyl alcohol. Using the ink as the main ingredient, each catalyst layer was produced by coating it onto one surface of a non-woven carbon fabric having a thickness of 250 micrometers using a screen-printing technique as is known in the art. The platinum content of the catalyst layers was set to be 0.3 mg/cm², and the perfluorocarbon sulfonate content was set to be 1.2 mg/cm².

The cathode and anode produced by forming the catalyst layers on the non-woven carbon fabric as described above were bonded by hot press to both sides of the middle part of the polymer electrolyte membrane. The hydrogen ion conductive polymer electrolyte membrane has an area slightly larger than the electrode, so that each catalyst layer was in full contact with the electrolyte membrane. A gasket made of a fluorocarbon rubber sheet which is 250 micrometers thick was bonded by hot press to the section of the electrolyte membrane that was exposed at the outside edge of the electrode. This assembly was used as the membrane electrode assembly for the resulting fuel cell stack. The hydrogen ion conductive polymer electrolyte membrane was a fluorocarbon sulfonate membrane of thickness 30 micrometers.

The electrically conductive separator was produced by machining gas passages and manifold holes in a 3 mm thick isotopic carbon material. It has the structure shown FIGS. 11 and 12. Each gas passage is a single pass and has a groove width of about 2 mm, a depth of about 1 mm, and a rib width between grooves of about 1 mm. Additionally, although not shown in FIGS. 11 and 12, cooling water passages were also divided to correspond to the gas passages.

Next, a fuel cell with 50 layers of cells as illustrated in FIG. 14 was assembled by alternately layering the electrically conductive separators and MEAs. A copper plate with gold coating was used for the current collector plate, a polyphenylene sulfide plate was used for the electrical insulation plate, and stainless steel was used for the end plates. The fastening pressure of the layer built cell was set to be 10 kgf/cm² of area of the electrode, and the layer built cell was structured so that the top part of the separator illustrated in FIG. 11 was positioned at the upper part of the cell.

The rated output conditions of the cell are a fuel usage rate of 75%, an oxygen usage rate of 40% and an electric current density of 0.3 A/cm².

The solid polymer fuel cell manufactured as described above was kept at 70 ° C. The fuel gas was humidified to a dew point of 70° C. and heated to 70° C. before supplying to the anode. The air (oxidant gas) was humidified to a dew point of 70° C. and heated to 70° C. before supplying to the cathode. The fuel gas is composed of 80% hydrogen, 20% carbon dioxide, and 10 ppm carbon monoxide.

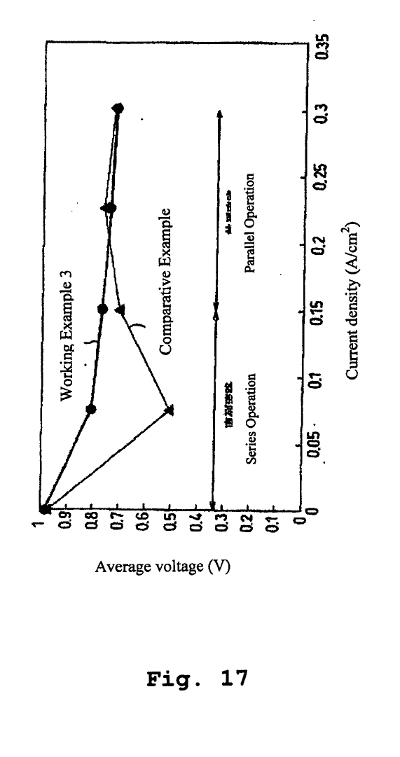

The current/voltage characteristics of the fuel cell were evaluated by varying the electric current density from a low load of 0.075 A/cm² current density, which is 25% of the rated output of the cell, to a load of 0.3 A/cm², which is the rated output load. The fuel usage rate during the test was set to be the same as the rated output condition. The results are shown in FIG. 17. The test was conducted with the gas passages switched to series operation below 0.15 A/cm² and to parallel operation above 0.15 A/cm². For comparison purposes, FIG. 17 also shows the current/voltage characteristic of a conventional fuel cell (the Comparative Example). The separators of the conventional cell employ a single pass gas passage structure.

As FIG. 17 shows, the fuel cell of the present example achieves stable operation without flooding even at a load of 0.075 A/cm². At this load level, operation of the conventional cell becomes difficult due to flooding caused by the lower gas flow rate. Although the present embodiment illustrated the case where two independent passages are employed, it is also possible to have a structure which employs more than two independent passages if the pressure loss in each passage is maintained at the same level.

### EXAMPLE 4

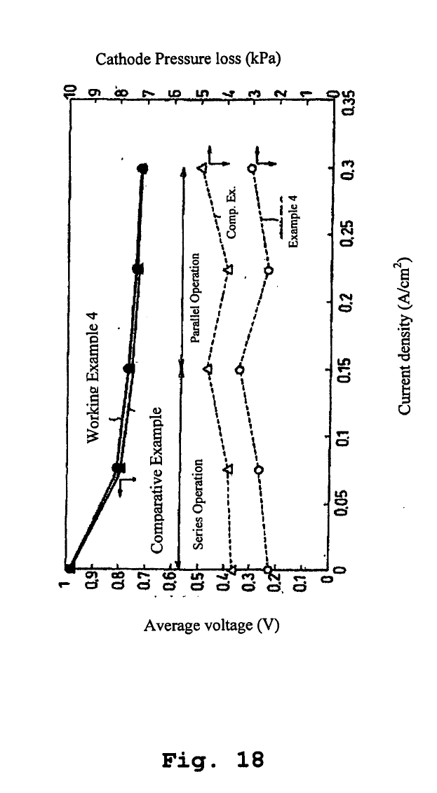

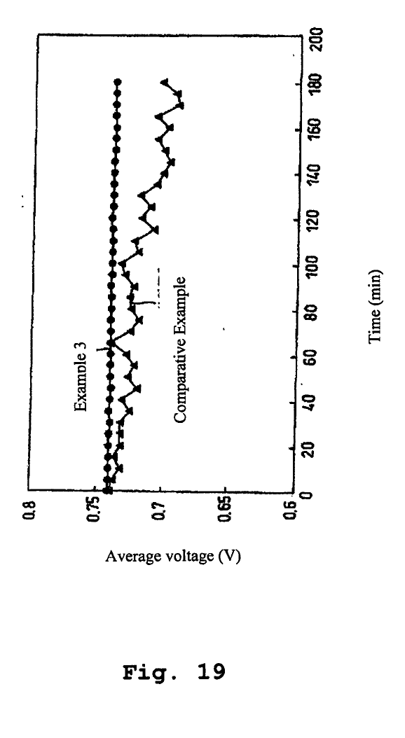

A mist trap was added as described in Embodiment 4, and a cell that was in all other respects equivalent to the cell of Example 3 was produced. The mist trap was a commercially available mechanical mist trap (1-LDC manufactured by Armstrong Co.). The current/voltage characteristics of the cell were measured under the same conditions as Example 3. The system was designed so that the overall pressure loss in the entire passages in Example 4 was set to be approximately 60% of the overall pressure loss in the entire passages in Example 3. The results are shown in FIG. 18. The results confirm that it is possible to obtain stable cell output with low pressure loss.

### EXAMPLE 5

Referring to FIG. 11, when the operation of the gas passages is switched from series to parallel, it is preferable to maintain the same direction of gas flow in the passages, otherwise the flow will be against gravity. If the gas flow is against gravity, the water droplets formed in the flow passages must be moved against gravity, resulting in larger pressure loss compared to the case in which the gas flows in the direction of gravity. As a result, pressure loss in each independent passage becomes uneven. In the section where the gas flow is against gravity, clogging of the gas passage by water droplets develops more easily, resulting in a substantial increase in the risk of flooding. Moreover, temperature distribution in the cell surface is generally determined by the direction of cooling water flow, and it is desirable to match the direction of the gas flow and cooling water flow in order to reduce the temperature near the gas inlet section and increase the temperature near the gas outlet section. This structure has the advantage that water is generated in larger amounts near the outlet, and water generated near the outlet can be more easily discharged from the separator. When the direction of gas flow changes, the relationship with the temperature distribution becomes unstable and water clogging is more likely to occur. Therefore, it is desirable to maintain the direction of gas flow in the direction of gravity.

The separator was structured and installed as illustrated in FIG. 11, with holes 111a and 112a at the top and holes 113b and 114b at the bottom. As shown in FIG. 13, the direction of gas flow does not change when the operation of the gas passages is switched from series to parallel. The direction of flow is consistent with gravity. FIG. 19 shows the change in voltage over time when the cell is operated at one half of the rated output load under the same conditions as Example 3. The comparative example shows the cell characteristic when the direction of gas flow is made to be against gravity by intentionally switching the inlet and outlet of the second gas passage. The results show that by maintaining the direction of gas flow with gravity, flooding was minimized and a more stable operation as achieved.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following claims.

What is claimed is:

1. A fuel cell stack comprising:
at least one cell A, which comprises a first and second separator disposed between and contacting opposing surfaces of an MEA, wherein the first separator has an inlet manifold to direct gas to and across one surface of the MEA and an outlet manifold linked to the inlet manifold to direct gas away from the one surface of the MEA; and
at least one cell B, which comprises a first and second separator disposed between and contacting opposing surfaces of an MEA, wherein the first separator has a first and second inlet manifold to direct gas to and across one surface of the MEA and a first and second outlet manifold linked to the first and second inlet manifolds, respectively, to direct gas away from the one surface of the MEA,
wherein the outlet of the first separator of cell A is linked to the second inlet manifold of the first separator of cell B.

2. The fuel cell stack according to claim 1:
wherein the second separator of cell A comprises an inlet manifold to direct gas to and across the other surface of the MEA and an outlet manifold linked to the inlet manifold to direct gas away from the other surface of the MEA;
wherein the second separator of cell B comprises a first and second inlet manifold to direct gas to and across the other surface of the MEA and a first and second outlet manifold linked to the first and second inlet manifolds, respectively, to direct gas away from the other surface of the MEA; and
wherein the outlet manifold of the second separator of cell A is linked to the second inlet manifold of the second separator of cell B.

3. The fuel cell stack according to claim 2 further comprising:
a first valve linked to the first inlet manifold of the first separator of cell B;
a second valve linked to the inlet manifold of the first separator of cell A;
a third valve linked to the first inlet manifold of the second separator of cell B;
a fourth valve linked to the inlet manifold of the second separator of cell A;
a fifth valve linked to the second outlet manifold of the first separator of cell B;
a sixth valve linked to the outlet manifold of the second separator of cell A;
a seventh valve linked to the outlet manifold of the second separator of cell A and the first outlet manifold of the second separator of cell B; and
an eight valve linked to the gas outlet of the first separator of cell A and to the first outlet manifold of the first separator of cell B.

4. The fuel cell stack according to claim 3 further comprising a controller to open and close the first through eight valves.

5. The fuel cell stack according to claim 4 wherein the controller opens or closes any one of the first through eight valves in response to a power mode of the fuel cell stack.

6. The fuel cell stack according to claim 5 wherein the controller operates cells A and B in parallel during a first power mode by opening valves 1, 2, 8, 3, 4 and 7 and closing the remaining valves; and wherein the controller operates cells A and B in series during a second power mode by opening valves 2, 5, 4, 6 and closing valves the remaining valves.

7. The fuel cell stack according to claim 2 wherein the first separators of cells A and B contact a cathode electrode surface of the MEA and the second separators of cells A and B contact the anode electrode surface of the MEA.

8. The fuel cell stack according to claim 2 wherein the fuel stack comprises a plurality of alternating cells of cell A and cell B.

9. A fuel cell stack comprising a plurality of unit cells, each of which comprises:
a first and second separator disposed between and contacting opposing surfaces of an MEA, wherein the first separator has at least two independent gas passages to supply gas across one surface of the MEA, and wherein each of the at least two independent gas passages has an inlet and an outlet manifold.

10. The fuel cell stack according to claim 9 wherein the at least two independent gas passages are connected in series by connecting the outlet manifold of an upstream gas passage and the inlet manifold of a downstream gas passage with pipes provided outside the first separator.

11. The fuel cell stack according to claim 10, further comprising a mist trap at the connection of the outlet and inlet manifolds.

12. The fuel cell stack according to claim 9 wherein the at least two gas passages of the first separator are arranged so that the direction of a gas flow is predominately in the direction consistent with gravity.

13. The fuel cell stack according to claim 9 wherein the second separator has at least two independent gas passages to supply gas across the other surface of the MEA, and wherein each of the at least two independent gas passages has an inlet and an outlet manifold.

14. The fuel cell stack according to claim 9 wherein the first separator has at least two independent cooling water passages on a surface opposing the MEA.

15. A fuel cell stack comprising:
a plurality of separators disposed between a plurality of MEAs; and
means for supplying gas to the plurality of separators parallelly during a first power mode and serially during a second power mode.

16. A method of operating a fuel cell stack, the method comprising:
supplying fuel gas to a plurality of cathode side separators in parallel during a first power mode; and
supplying fuel gas to the plurality of cathode side separators in series during a second power mode.

17. The method according to claim 16 wherein fuel gas is supplied to the plurality of cathode side separators in parallel by independently supplying the fuel gas to at least two of the plurality of cathode separators, and
wherein fuel gas is supplied to the plurality of cathode side separators in series by connecting an outlet manifold of one of the plurality of cathode side separators to an inlet manifold of another of the plurality of cathode side separators.

18. The method according to claim 16 wherein fuel gas is supplied to the plurality of cathode side separators in parallel by supplying the fuel gas to individual separators having independent gas passages, and
wherein the fuel gas is supplied to the plurality of cathode side separators in series by connecting an outlet manifold of one of the independent gas passages on each cathode side separator to an inlet manifold on the same separator.
